(19) United States
(12) Patent Application Publication
(10) Pub. No.: US 2007/0050442 A1
(43) Pub. Date: Mar. 1, 2007

(54) Method, apparatus, and program for modular arithmetic

(75) Inventors: Naofumi Takagi, Nagoya-shi (JP); Marcolo E. Kaihara, Nagoya-shi (JP)

Correspondence Address: SUGHRUE MION, PLLC, 2100 PENNSYLVANIA AVENUE, N.W., SUITE 800, WASHINGTON, DC, 20037, US

(73) Assignee: National University Corporation Nagoya University

(21) Appl. No.: 11/365,665

(22) Filed: Mar. 2, 2006

(30) Foreign Application Priority Data
Aug. 24, 2005 (JP) 2005-242956

(51) Int. Cl. G06F 7/00

(52) U.S. Cl. 708/492

(57) ABSTRACT

A computing method for accelerating the iterations of modular multiplications is provided. In a newly defined image, variables U and V in a residue system are transformed to X=U·R mod M and Y=V·R mod M, and a modular multiplication U·V mod M is replaced with X·Y·R⁻¹ mod M=U·V·R mod M. If R=r^{m} where m is an integer that satisfies m<n, the multiplier U is transformed as X=U·r^{m} mod M, and the multiplicand Y is transformed as Y=V·r^{m} mod M. That is, X and Y are the images of U and V. The modular multiplication U·V mod M is replaced with X·Y·r^{-m} mod M. In this manner, the parameter m is introduced to enable splitting of the multiplier Y into two parts of an upper part Y_{H} and a lower part Y_{L} and then process the two parts in parallel.

### FIELD OF THE INVENTION

This invention relates to a method, apparatus, and program for modular arithmetic.

### BACKGROUND OF THE INVENTION

In order to ensure the security of data communication on networks, public-key cryptosystems, such as RSA (Rivest-Shamir-Adleman), have been conventionally used to encrypt and decrypt data.

Such public-key cryptosystems can enhance the security in sending and receiving information because in these cryptosystems decryption through unauthorized methods can be difficult as the size (digit number) of the public keys is increased.

However, the public key cryptosystems such as RSA require modular exponentiation for encryption and decryption. The amount of computation for the modular exponentiation grows large corresponding to the size of the public keys.

Most implementations of the modular exponentiation are based on iterations of modular multiplications with very long integers. A great amount of time has generally been required for the iterations of these modular multiplications.

Accordingly, the faster the iterations of modular multiplications can be, the longer the size of the keys can be used. Consequently, tighter cryptographic security can be achieved for data communication on networks using the longer keys.

As a method of accelerating the iterations of modular multiplications, there is a transformation of variables to Montgomery representations and a replacement of individual modular multiplications to Montgomery multiplications (see Document 1). As a method of accelerating the Montgomery multiplications, there is an increase of the radix (see Document 2).

Also, as a method of accelerating individual modular multiplications, there is an increase of the radix using interleaved algorithms (see Document 3).

[Document 1] P. L. Montgomery, “Modular Multiplication without Trial Division”, Mathematics of Computation, vol. 44, no. 170, pp. 519-521, April 1985.

[Document 2] S. E. Eldridge and C. D. Walter, “Hardware Implementation of Montgomery's Modular Multiplication Algorithm”, IEEE Transactions on Computers, vol. 42, no. 6, pp. 693-699, June 1993.

[Document 3] N. Takagi, “A Radix-4 Modular Multiplication Hardware Algorithm for Modular Exponentiation”, IEEE Transactions on Computers, vol. 41, no. 8, pp. 949-956, August 1992.

### SUMMARY OF THE INVENTION

The improved methods of modular multiplication described in Documents 2 and 3 increase the radix of the operation to reduce the number of clock cycles required for the operation.

However, an increase of the radix causes an increase in the complexity of operation circuit, and thus leads to an increase of cycle time for the operation. Accordingly, there is a problem that an increase of the radix for the operation may result in a decrease in the rate of acceleration.

The present invention is made to solve the above problems. One object of the present invention is to provide a method for accelerating the iterations of modular multiplications in a residue system without increasing the cycle time.

For the purpose of clarifying an understanding of the present invention, how the technical concept occurred of the present invention will be explained hereafter.

As noted above, implementations of public-key cryptosystems such as RSA are based on iterations of modular multiplications with very long integers for encryption and decryption.

In these iterations of calculations with long integers, a long integer is split into an upper part and a lower part. The two parts are then processed in parallel in order to accelerate the calculations.

However, modular multiplication is an operation of multiplying a multiplicand by a multiplier and-dividing the result of the multiplication by a modulus M to obtain the remainder. Accordingly, there is no merit of splitting the multiplier and processing the split parts in parallel.

For the sake of facilitating understanding, a particular example is described below.

Let there be a modular multiplication where a modulus M=9753, e.g., 5432x4321 mod 9753.

If the above modular multiplication is calculated as it currently exists, a division of 8 digits by 4 digits is necessary.
5432x4321 mod 9753=23471672 mod 9753=5954

Next, the multiplier 4321 is split into the upper 2 digits ‘43’ and the lower 2 digits ‘21’, so that the upper part and the lower part can be computed in parallel.
5432x4321 mod 9753=(5432x4300 mod 9753+5432x21 mod 9763) mod 9753

The actual results of the respective operations are 23357600 mod 9753=8918 for the upper part of the multiplier, and 114072 mod 9753=6789 for the lower part of the multiplier.

In this manner, when the multiplier 4321 is split into the upper 2 digits and the lower 2 digits, the operation on the lower part is a division of 6 digits by 4 digits. Clearly, this calculation is made easier.

However, a division of 8 digits by 4 digits is still required for the operation on the upper part. In other words, in modular multiplication, simply splitting the multiplier into an upper part and a lower part for parallel processing still necessitates a division between the same number of digits for the upper part as existed before the splitting (division of 8 digits by 4 digits). Consequently, this brings no significant advantage for parallel processing in modular multiplication.

In the present invention, a residue system is transformed into a newly defined image. In the newly defined image, parallel computing with a decreased number of digits can be achieved for modular arithmetic in both the upper and lower parts, Thus, the calculations can be accelerated.

Now, the relationship between the modular multiplication and the newly defined image will be explained by referring to FIG. 1.

As shown in FIG. 1, two variables U and V in a residue system are respectively transformed to X=U·R mod M, and Y=V·R mod M in a newly defined image.

Also, a modular multiplication in the residue system, U·V mod M, is replaced with X·Y·R⁻¹ mod M=U·V·R mod M.

If R=r^{m} when M is in a radix r, the multiplicand U is transformed as X=U·r^{m} mod M; as shown in S100 of FIG. 1. Likewise, the multiplier V is transformed as Y=V·r^{m} mod M (see S120 of FIG. 1). That is, U and V are transformed into X and Y in the newly defined image.

Subsequently, the modular multiplication, U·V mod M, is replaced by X·Y·r^{-m} mod M in the newly defined image (see S104 of FIG. 1).

In this manner, the parameter m is introduced to enable the splitting of the n-digit multiplier Y into two parts comprising an upper (n-m)-digit part Y_{H}, and a lower m-digit part Y_{L}. Therefore, the two parts can be processed in parallel. Here, the parameter m is an integer and satisfies 0<m<n.

As detailed above, in the newly defined image the variable (multiplier) Y is split into the upper part Y_{H} and the lower part Y_{L}, and both parts are computed in parallel. The results of the operations are then transformed back to the original representations so that the result of the modular multiplication is finally obtained.

In one aspect of the present invention, a method of modular arithmetic, in a modulo M system where M is an integer, includes the steps of transforming a variable U to a variable X=U·R mod M and a variable V to Y=V·R mod M, where R is a constant relatively prime to modulus M and smaller than M; performing arithmetic by replacing a modular multiplication, U·V mod M, with the following formula (1),
X·Y·R⁻¹ mod M (1);
and inversely transforming a result Z by the following formula (2),
Z·R⁻¹ mod M (2);
so as to obtain the result of the arithmetic.

According to the above computing method, each variable U and V is transformed to X=U·R mod M and Y=V·R mod M using a constant R. The modular multiplication, U·V mod M, in the original residue system, is replaced with X·Y·R⁻¹ mod M in the newly defined image. Assuming that the algebraic system obtained by the transformation of the variables and the replacement of the modular multiplication is a “newly defined image”, the operations in the residue system can be performed in the same manner in the newly defined image.

In the modular multiplication in this newly defined image, the multiplier Y can be split into an upper part Y_{H} and a lower part Y_{L} for calculation as mentioned above.

Accordingly, if an operation in a residue system is computed in the newly defined image, even though the above transformation and the inverse transformation are necessary, the splitting of the multiplier Y into an upper part Y_{H} and a lower part Y_{L} is enabled in the modular multiplication. Therefore, for example, a calculation can be accelerated for public key encryption that requires iterations of modular multiplications in the residue system.

That is, in the newly defined image, the parallel execution of the operations for the upper part Y_{H} and the lower part Y_{L} enables the attainment of the same computing result as in the modular multiplication in the residue system. Therefore, operations requiring iterations of modular multiplications in the residue system can be accelerated.

Here, “mod M” in the above formulas (1) and (2) corresponds to modulo M arithmetic. The results of these operations are generally values from 0 to (M-1). In the present application, however, the results of the operations also include values that are congruent to modulo M as well as negative or not less than M. In the present application, not only “mod M” in the formulas (1) and (2) but also “mod M” shown in the other parts has the same meaning.

In the newly defined image, it is preferable that the constant R is defined as R=r^{m} when the n-digit variable Y is represented in a radix r. The variable Y is split into an upper (n-m)-digit part Y_{H} and a lower m-digit part Y_{L} by the following formula (3),
Y=Y_{H}·r^{m}+Y_{L} (3)
where m is an integer that satisfies m<n.

The formula (1) is then transformed to the following formula (4).
(X·Y_{H} mod M+X·Y_{L}·R⁻¹ mod M) mod M (4)

Partial formulas (4a) and (4b) of the formula (4),
X·Y_{H} mod M (4a)
X·Y_{L}·R⁻¹ mod M (4b)
may be processed in parallel.

As above, if the formulas (4a) and (4b) are processed in parallel, acceleration of the operation can be easy in the newly defined image corresponding to the modular multiplication in the residue system.

That is, since the manner of operations by the formulas (4a) and (4b) are different from each other, the calculation speeds are also different from each other. Therefore, the calculation speeds are adjusted to be equal to each other.

For example, if the calculation speed of the formula (4a) is faster, the digit number (n-m) of the upper part Y_{H} is set to be larger than the digit number m of the lower part Y_{L} when splitting the multiplier Y. To the contrary, if the calculation speed of the formula (4b) is faster, the digit number (n-m) of the upper part Y_{H} is set to be smaller than the digit number m of the lower part Y_{L}. In this manner, the both operations can be ended at almost the same time. Thus, the total calculation time can be easily shortened, that is, the calculation speed can be accelerated.

As detailed above, in the newly defined image the modular multiplication in the residue system can be accelerated by splitting the multiplier Y into an upper part Y_{H} and a lower part Y_{L}. As mentioned in the BACKGROUND ART, there are various computing methods for the formulas (4a) and (4b) that respectively calculate the split upper part Y_{H} and lower part Y_{L}.

For example, if the formula (4a) is calculated using an interleaved algorithm and the formula (4b) is calculated using Montgomery multiplication, conventional programs and operation circuits can be used. As a result, the configuration of the programs and operation circuits can be simplified. This saves costs for the programs and operation circuits.

The calculations by the formulas (4a) and (4b) are not necessarily independent of each other. The processes of calculating the formulas (4a) and (4b) may be synchronized so that each processes' intermediate results can be passed to the other or exchanged during the calculations.

Also, “n-digit” in the n-digit, radix-r variable Y represents the digit number set for the variable Y. For example, if r=2 and n=8 (i.e., 8 digits in a radix 2), a variable such as Y=00001010 where the upper digits (upper 4 digits, in the present case) are zero (0) is also included.

In another aspect of the present invention, an apparatus for modular multiplication is provided in which, in a modulo M system where M is a radix-r integer, and M and r are relatively prime to each other, the apparatus includes a splitter, a first modular multiplier, a second modular multiplier, and an adder. When an n-digit, radix-r variable Y, a modulus M, and a variable X are inputted, the splitter splits the variable Y into an upper (n-m)-digit part Y_{H} and a lower m-digit part Y_{L}. The first modular multiplier calculates X·Y_{H} mod M and outputs a calculation result. The second modular multiplier calculates X·Y_{L}·r^{-m} mod M and outputs a calculation result. The adder sums up the output from the first modular multiplier with the output from the second modular multiplier, and outputs the result of the addition.

The output of the apparatus for modular multiplication constituted as above, that is, the result outputted from the adder, can be, other than 0 to (M-1), congruent to modulo M and negative or not less than M.

According to the above apparatus for modular multiplication, the operation of the upper (n-m)-digit part executed by the first modular multiplier and the operation of the lower m-digit part executed by the second modular multiplier are performed in parallel to each other. The digit numbers of variables Y_{H} and Y_{L} are less than the variable Y prior to splitting. Therefore, the calculation speeds are accelerated in the respective first and second modular multipliers. Accordingly, it is possible to accelerate the calculation speed in the newly defined image corresponding to the modular multiplication in the residue system.

Also as noted above, the operation executed in the first modular multiplier and the operation executed in the second modular multiplier are processed in parallel. Thus, the calculation speed can be accelerated in the newly defined image corresponding to the modular multiplication in the residue system.

That is, the operation executed by the first modular multiplier and the operation executed by the second modular multiplier are different in respect to calculation methods. Thus, the respective calculation speeds are different. Therefore, the operation executed by the first modular multiplier and the operation executed by the second modular multiplier are performed in accordance with their respective calculation speeds.

For example, if the calculation speed is faster in the first modular multiplier, the multiplier Y is split such that the digit number (n-m) of the upper part Y_{H} is larger than the digit number m of the lower part Y_{L}. To the contrary, if the calculation speed is faster in the second modular multiplier, the multiplier Y is split such that the digit number (n-m) of the upper part Y_{H} is smaller than the digit number m of the lower part Y_{L}. Then, the operations in both the modular multipliers can end at almost the same time. Therefore, the overall calculation time can be easily reduced. In other words, the calculation speed can be accelerated.

As noted above, by splitting the multiplier Y into an upper part Y_{H} and a lower part Y_{L} and calculating the two parts in parallel, it is possible to speed up modular multiplications. There are various circuit structures for the first modular multiplier and the second modular multiplier.

For example, if the first modular multiplier uses a circuit for an interleaved modular multiplication and the second modular multiplier uses a circuit for Montgomery multiplication, the circuits can be easily configured since conventional circuits can be used. This saves the costs for the apparatus for modular multiplication.

The process in the first modular multiplier and the process in the second modular multiplier are not necessarily independent of each other. The process in the first modular multiplier and the process in the second modular multiplier may be synchronized. The first modular multiplier and the second modular multiplier may be configured such that intermediate results are passed to the other or exchanged during the execution of the respective processes.

In another further aspect of the present invention, a program is provided that allows a computer to perform the aforementioned method for modular arithmetic.

That is, a computer program is provided in which, in a modulo M system where M is an integer M, variables U and V are respectively transformed into variables X and Y such that X=U·R mod M and Y=V·R mod M where R is a constant relatively prime to the modulus M and smaller than M. Arithmetic is performed by replacing a modular multiplication, U·V mod M, with the aforementioned formula (1). A result Z is inversely transformed by the formula (2) so that the result of the arithmetic is obtained.

Also, in the above program the constant R is defined as R=r^{m}, where the modulus M and the variable Y are n-digit values in a radix r. The variable Y is split into the upper (n-m)-digit part Y_{H} and the lower m-digit part Y_{L} by the formula (3) (m is an integer which satisfies m<n). The formula (1) is transformed to the formula (4), and the formula (4a) and the formula (4b) are executed in parallel.

Such a program can achieve the same effects described in the aforementioned computing method.

The above program may be stored in readable storage media such as FD, MO, DVD-ROM, CD-ROM, hard disk, etc. The program can be loaded to the computer as necessary. Alternately, the program may be written in ROM or backup RAM, which are then incorporated in a computer.

### BRIEF DESCRIPTION OF THE DRAWING FIGURES

The invention will now be described by way of example, with reference to the accompanying drawings in which:

FIG. 1 is a diagram showing a relationship between variables in a residue system and representations in a newly defined image;

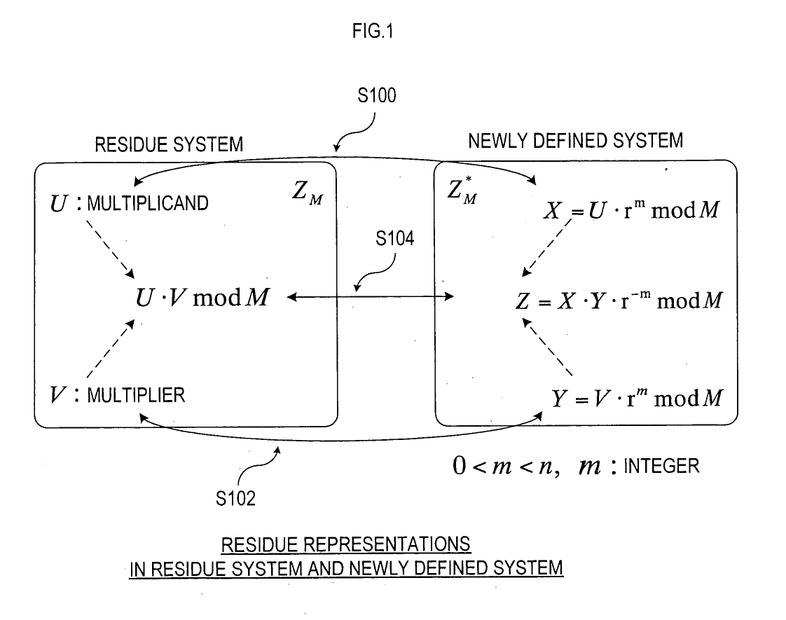

FIG. 2 is a diagram showing the calculation steps in the newly defined image where a multiplicand X and a multiplier Y are both 8-bit values; and

FIG. 3 is a block diagram showing a structure of an apparatus for modular multiplication.

### BEST MODE TO CARRY OUT THE INVENTION

(Computing Method in a Newly Defined Representation)

Lot R be r^{m}, where 0<m<n. R=r^{m} is relatively prime to M.

As an efficient computing method in this newly defined image, a radix-2 version will be described below.

Let M be a modulus where rⁿ⁻¹<M<rⁿ, and M is relatively prime to r. This operation receives inputs of an n-digit multiplicand X and an n-digit multiplier Y (0≦X, Y<M), and outputs Z=X·Y·r^{-m} mod M. Particularly, this operation is executed according to the following steps.

In Step 1, S and T are initialized to store zero (0). A stores a multiplicand X. B_{H} and B_{L} respectively store Y_{H} and Y_{L}, where Y_{H} is the upper (n-m)-digit part and Y_{L} is the lower m-digit part of a multiplier Y split by a parameter m.

That is, the digit number of the lower B_{L} is m, and the digit number of the upper B_{H} is (n-m).

In Step 2, a conventional interleaved algorithm is applied to A and B_{H} in order to perform modular multiplication for the (n-m)-digit part and to obtain the result S. Also, a conventional Montgomery multiplication algorithm is applied to A and B_{L} in order to perform a calculation for the m-digit part and to obtain T.

The interleaved modular multiplication and the Montgomery multiplication in Step 2 are processed in parallel. When the parallel processing is ended and S and T are obtained, the process moves to Step 3.

In Step 3, modular addition of S and T modulo M is performed to obtain the output Z. The output Z obtained in this manner is the result of the computation in the newly defined image.

The above steps are formulated as follows.

Inputs: M: rⁿ⁻¹<M<rⁿ, gcd(M, r)=1
X, Y: 0≦X, Y<M

Output: Z=X·Y·r^{-m} mod M

Algorithm:
Step 1: A: =X; M: =M; S: =0; T: =0; B_{H}: =Y_{H}; B_{L}:
=Y_{L} where Y=Y_{H}·r^{m}+Y_{L}
Step 2: {S: =Interleaved-modmul (A, B_{H}, M); T:
=Montgomery modmul (A, B_{L}, M);}
Step 3: Z: =S+T mod M;

In the above Step 2, Interleaved_modmul (A, B_{H}, M) represents an interleaved modular multiplication, where A indicates a multiplicand, B_{H} indicates a multiplier, and M indicates a modulus. Likewise, Montgomery_modmul (A, B_{L}, M) represents a Montgomery multiplication, where A indicates a multiplicand, B_{L} indicates a multiplier, and M indicates a modulus. Braces { } represent a parallel execution.

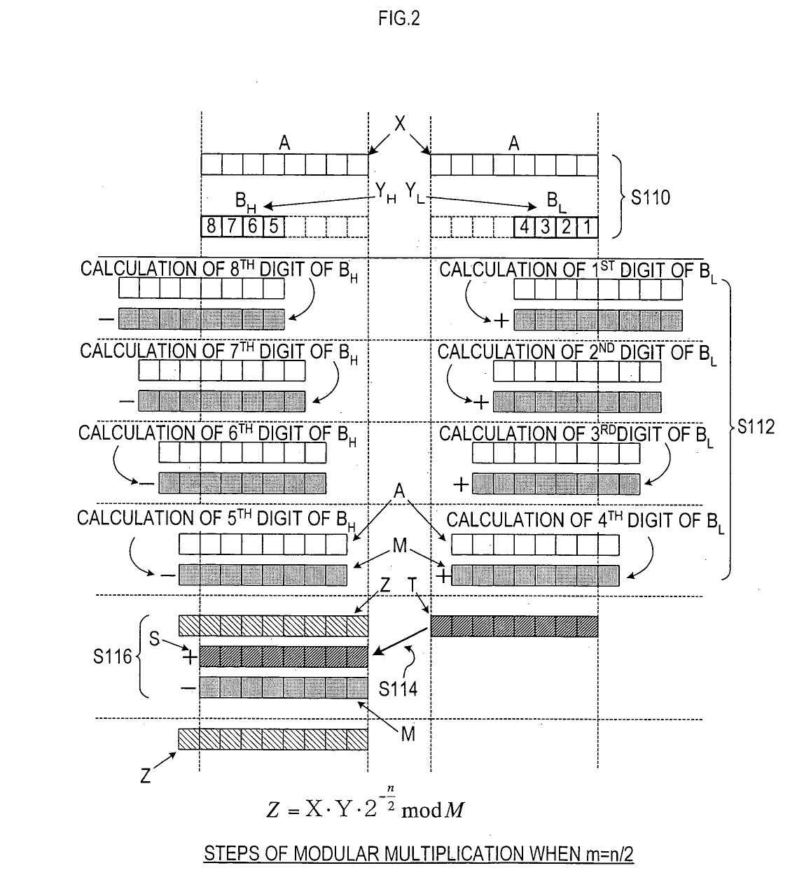

Now, in the above noted computation in the newly defined image, an operation for the case in which the multiplier Y is split into the halves, i.e., m=n/2, is explained by way of FIG. 2.

FIG. 2 is a diagram showing the calculation steps in the newly defined image whore a multiplicand X and a multiplier Y are both 8-bit values. In the present embodiment, the radix-2 signed-digit representation is employed so that all additions and subtractions are performed without carry propagation.

This operation receives inputs of an n-bit multiplicand X, an n-bit multiplier Y (0≦X, Y<M), and outputs Z=X·Y·r^{-n/2} mod M. Particularly, this operation is executed according to the following steps.

In Step 1, S and T are initialized to store zero (0). A stores a multiplicand X. B_{H} and B_{L} respectively store Y_{H} and Y_{L} where Y_{H} is the upper (n-m)-digit part and Y_{L} is the lower m-digit part of a multiplier Y split by a parameter m (=n/2) (see S110 in FIG. 2).

In Step 2, a conventional interleaved algorithm is applied to A and n/2-bit B_{H}, whereas a conventional Montgomery multiplication algorithm is applied to A and n/2-bit B_{L}. These calculations are performed in parallel and the results S and T are obtained (see S112 of FIG. 2).

The calculation of the upper part is performed by n/2-time iterations of the following procedures (H1) to (H7).
(H1) Shift S to the left (to the higher rank) by one digit.
(H2) Let the (n+1)^{th} digit of S after the shift (carry after the shift), n^{th} digit, (n−1)^{th} digit be q₁, i.e., q₁=[sₙ₊₁sₙ sₙ₋₁].
(H3) If q₁ is larger than zero (0), subtract the modulus M from S and update S. If q, is smaller than zero (0), add the modulus M to S and update S.
(H4) Carry out logical AND between the multiplicand A and the highest bit bₙ₋₁ of the multiplier B_{H}. Add the result to S and update S.
(H5) Let the (n+1)^{th} digit of new S, n^{th} digit, (n−1)^{th} digit be q₂, i.e., q₂=[sₙ₊₁sₙ sₙ₋₁].
(H6) If q₂ is larger than zero (0), subtract the modulus M from S and update S. If q₂ is smaller than zero (0), add the modulus M to S and update S.
(H7) Shift B_{H} to the left by one bit.

The calculation of the lower part is performed by n/2-time iterations of the following procedures (L1) to (L4).
(L1) Carry out logical AND between the multiplicand A and the least significant bit b₀ of the multiplier B_{L}. Add the result to T and update T.
(L2) Let the least significant digit t₀ of T be q₃.
(L3) If qₛ is not zero (0), add the modulus M to T and then shift T to the right by one digit and update T. If q₃ is zero (0), shift T to the right by one digit and update T.
(L4) Shift B_{L} to the right by one digit.

As noted above, the result S of the upper part of the modular multiplication and the result T of the lower part of the modular multiplication are obtained via parallel processing.

In Step 3, the addition of S and T modulo M is performed to obtain a new S (see S114 of FIG. 2). The (n+1)^{th} digit, n^{th} digit, (n−1)^{th} digit of the new S are set to q₂, i.e., q₂=[sₙ₊₁sₙ sₙ₋₁]. If q₂ is larger than zero (0), the modulus M is subtracted from S so that S is updated. If q₂ is smaller than zero (0), the modulus M is added to S so that S is updated.

In Step 4, S is transformed from the radix-2 signed digit representation to a normal binary representation through a known computing method. The result is set to the output Z (not shown in FIG. 2).

In Step 5, if the output Z is smaller than zero (0), the modulus M is added to the output Z so that the output Z is updated (see S116 of FIG. 2).

The output Z obtained in this manner is the result of the operation modulo M between the multiplier Y and the multiplicand X in the newly defined image.

The above steps are formulated as follows.

Inputs: M: 2ⁿ⁻¹<M<2ⁿ, ged(M, 2)=1
X, Y: 0≦X, Y<M

Output: Z=X·Y·2^{·n/2} mod M (0≦Z<M)

Algorithm:
Step 1: A: =X; B_{H}: =Y_{H}; B_{L}: =Y_{L}; S: =0; T: =0; M:
=M;
Step 2: for i: =1 to n/2
   Do H and L in parallel
   H: do
      S: =2·S;
      q₁:=[sₙ₊₁sₙ sₙ₋₁];
      if q₁>0 then S: =S−M
      elseif q₁<0 then S: =S+M;
      S: =S+bₙ₋₁·A;
      q₂: =[sₙ₊₁sₙ sₙ₋₁];
      if q₂>0 then S: =S−M
      elseif q₂<0 then S: =S+M;
      B_{H}: =B_{H}>>1;
      enddo
   L: do
      T: =T+b₀·A;
      q₃: =t₀
      if q₃≠0 then T: =(T+M)>>1
      else T: =T>>1;
      B_{L}: =B_{L}>>1;
      enddo
   endfor
Step 3: S: =S+T;
   q₂: =sₙ₊₁sₙ sₙ₋₁];
   if q₂>0 then S; =S−M
   elseif q₂<0 then S: =S+M;
Step 4: Z: =SD2_to_Binary (S);
Step 5: if Z<0 then Z: =Z+M;

In the above noted radix-2 version of the calculation in the newly defined image, the n-bit multiplier Y is split into halves (n/2). The upper part is calculated using the interleaved modular multiplication algorithm and the lower part is calculated using the Montgomery multiplication algorithm The two calculations are performed in parallel almost simultaneously.

Accordingly, the modular multiplication in the newly defined image can be performed in about half of the time required when the interleaved modular multiplication is used for the modular multiplication of the whole n-bit multiplier.

That is, generally, the Montgomery multiplication is faster than the interleaved modular multiplication if the bit number to be processed is the same. Therefore, when the interleaved multiplication of the n/2-bit number (i.e., the modular multiplication of the upper part) is ended, the Montgomery multiplication of the n/2-bit number (i.e., calculation of the lower part) has been ended.

Accordingly, the modular multiplication of the entire multiplier in the newly defined image can be performed in about half of the time required when the interleaved modular multiplication is adopted for the modular multiplication of the whole multiplier.

In the present embodiment, the bit number of the lower part and the upper part of the multiplier is set to be the same, i.e., m is set as n/2. However, the bit number of the lower part and the upper part may be set differently.

For instance, in consideration of the difference in computing time between the interleaved algorithm and the Montgomery algorithm, it is possible to determine a manner of splitting that further reduces the overall computing time. That is, if a ratio of the computing speed between the interleaved algorithm and the Montgomery algorithm is p:q, the bit number m of the lower part is set to be about n·q/(p+q). Then, the computing time of the upper part and the computing time of the lower part will be approximately the same, and the overall computing time can be reduced.

(Description of an Apparatus for Modular Multiplication)

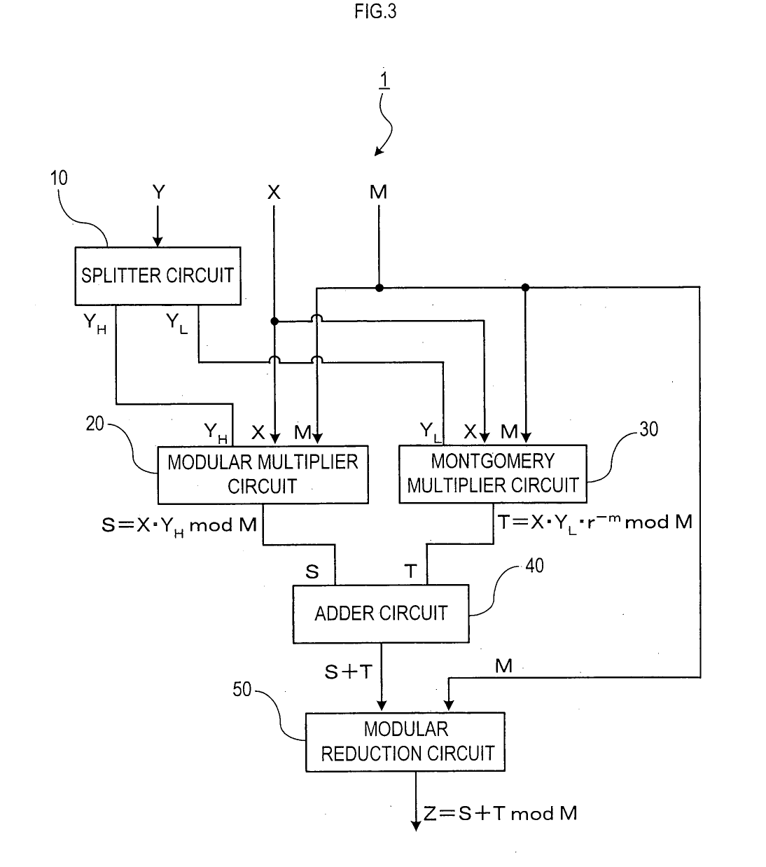

From now on, a modular multiplication apparatus 1 for executing an algorithm in the newly defined image will be described by way of FIG. 3.

FIG. 3 is a block diagram showing a structure of the modular multiplication apparatus 1.

As shown in FIG. 3, the modular multiplication apparatus 1 mainly includes a splitter circuit 10, a modular multiplier circuit 20, a Montgomery multiplier circuit 30, an adder circuit 40, and a modular reduction circuit 50.

The splitter circuit 10 is a circuit for splitting an inputted n-digit, radix-r variable Y into an upper (n-m)-digit part Y_{H} and a lower m-digit part Y_{L}. The parameter m used for splitting the n-digit variable Y into the upper part Y_{H} and the lower part Y_{L} may be internally provided in advance in the splitter circuit 10, or may be externally submitted.

The modular multiplier circuit 20 is a known circuit that calculates the following formula (10) and outputs the result S to the adder circuit 40,
S=X·Y_{H} mod M (10)
where X is the inputted variable, Y_{H} is the upper (n-m)-digit part of the variable Y split in the splitter circuit 10, and M is the modulus.

The Montgomery multiplier circuit 30 is a known circuit that executes a calculation based on Montgomery multiplication, i.e., the following formula (20), and outputs the result T to the adder circuit 40.
T=X·Y_{L}·r^{-m} mod M (20)
where X is the inputted variable, Y_{L} is the lower m-digit part of the variable Y split in the splitter circuit 10, and M is the modulus.

The adder circuit 40 is a known circuit that receives the output S from the modular multiplier circuit 20 and the output T from the Montgomery multiplier circuit 30 and calculates S+T as an output.

The modular reduction circuit 50 is a known circuit that receives the output S+T from the adder circuit 40 and the input of the modulus M to perform modular reduction, and outputs Z. That is, the modular reduction circuit 50 outputs Z by the following formula (30).
Z=S+T mod M (30)

The flow of the calculation performed in the above constituted modular multiplication apparatus 1 is explained hereafter.

The modular multiplication apparatus 1 receives inputs of an n-digit, radix-r variable Y, a variable X, and a modulus M.

The inputted variable Y is submitted to the splitter circuit 10. The variable X is submitted to the modular multiplier circuit 20 and the Montgomery multiplier circuit 30. The modulus M is submitted to the modular multiplier circuit 20, the Montgomery multiplier circuit 30, and the modular reduction circuit 50.

The variable Y submitted to the splitter circuit 10 is split to an upper (n-m)-digit part Y_{H} and a lower m-digit part Y_{L}. The upper part Y_{H} is submitted to the modular multiplier circuit 20. In the modular multiplier circuit 20, the modular multiplication is performed according to the above formula (10) and the result S is outputted. The lower m-digit part Y_{L} is submitted to the Montgomery multiplier circuit 30. In the Montgomery multiplier circuit 30, a calculation based on Montgomery multiplication is performed according to the above formula (20) and the result T is outputted.

The output S from the modular multiplier circuit 20 and the output T from the Montgomery multiplier circuit 30 are submitted to the adder circuit 40 and added together. The output and the modulus M are submitted to the modular reduction circuit 50. The modular reduction is performed according to the above formula (30) and the result Z is outputted.

According to the modular multiplication apparatus 1 as above, the multiplier Y is split into two parts, i.e., the upper part Y_{H} and the lower part Y_{L}. The modular multiplications for the respective upper part and lower part are independently performed in parallel. Accordingly, compared to a conventional computing method in which modular multiplication is performed to the n-digit multiplier as is, the modular multiplication described above can be executed in less time.

In the above, one embodiment of the present invention is described. However, the present invention is not limited to the above embodiment and other modifications and variations are possible without departing from the scope of the present invention.

For instance, in the present embodiment the interleaved algorithm is used for the operation (formula (4a)) of the upper part of a multiplier, whereas the Montgomery multiplication is used for the operation (formula (4b)) of the lower part of the multiplier. However, the respective operations are not limited to the above algorithms. Any other algorithms may be used as long as those algorithms mathematically permit parallel processing.

In parallel processing, the operations based on the formulas 4a and 4b are not necessarily independent of each other. The operations may be synchronized during the processes, and the intermediate results may be passed to the other or exchanged during the operations.

Likewise, the processes in the modular multiplier circuit 20 and the Montgomery multiplier circuit 30 are not necessarily independent of each other. The modular multiplier circuit 20 and the Montgomery multiplier circuit 30 may be designed such that the processes can be synchronized, and the intermediate results can be passed to the other or exchanged during the processing.

Furthermore, in the modular multiplication apparatus 1, the output of the modular reduction circuit 50 is set as Z. However, the output of the adder circuit 40 may be submitted to the other circuits or devices, such as another modular multiplier circuit, and further operations may be performed based on the result from the adder circuit 40.

What is claimed is:

1. A method for modular arithmetic, in a modulo M system where M is an integer, comprising the steps of:
transforming a variable U to a variable X=U·R mod M, and a variable V to Y=V·R mod M where R is a constant relatively prime to modulus M and smaller than M,
performing arithmetic by replacing a modular multiplication, U·V mod M, with the following formula (1),
X·Y·R⁻¹ mod M (1);
and inversely transforming a result Z by the following formula (2),
Z·R⁻¹ mod M (2);
so as to obtain the result of the arithmetic.

2. The method for modular arithmetic set forth in claim 1, when the variable Y is an n-digit value in a radix r, further comprising the steps of
defining the constant R as:
R=r^{m}, where m is an integer that satisfies m<n,
splitting the variable Y into an upper (n-m)-digit part Y_{H} and a lower m-digit part Y_{L} by the following formula (3),
Y=Y_{H}·r^{m}+Y_{L} (3);
transforming the formula (1) to the following formula (4),
(X·Y_{H} mod M+X·Y_{L}·R⁻¹ mod M) mod M (4);
and executing partial formulas (4a) and (4b) of the above formula (4),
X·Y_{H} mod M (4a);
X·Y_{L}·R⁻¹ mod M (4b);
in parallel processing.

3. The method set forth in claim 1 for accelerating iterations of modular multiplications for an electronic device.

4. An apparatus for modular multiplication in which, in a modulo M system where M is a radix-r integer, and M and r are relatively prime to each other, the apparatus comprises:
a splitter that splits an n-digit, radix-r variable Y into an upper (n-m)-digit part Y_{H} and a lower m-digit part Y_{L}, when the variable Y, a modulus M, and a variable X are inputted to the apparatus;
a first modular multiplier that calculates X·Y_{H} mod M and outputs a calculation result;
a second modular multiplier calculates X·Y_{L}·r^{-m} mod M and outputs a calculation result; and
an adder that sums up the output from the first modular multiplier and the output from the second modular multiplier, and outputs a result of addition.

5. The apparatus for modular multiplication set forth in claim 4, further comprising a modular reduction device that receives the result of addition from the adder, and outputs a result of a modulo M reduction.

6. A program that allows a computer to execute the method of modular arithmetic according to claim 1.

7. A program that allows a computer to execute the method of modular arithmetic according to claim 2.

8. A computer-readable recording medium on which source code is recorded that permits a computer to execute a method for accelerating iterations of modular multiplications, in a modulo M system where M is an integer, comprising the steps of:
transforming a variable U to a variable X=U·R mod M, and a variable V to Y=V·R mod M where R is a constant relatively prime to modulus M and smaller than M,
performing arithmetic by replacing a modular multiplication, U·V mod M, with the following formula (1),
X·Y·R⁻¹ mod M (1);
and inversely transforming a result Z by the following formula (2),
Z·R⁻¹ mod M (2);
so as to obtain the result of the arithmetic.

9. The computer-readable recording medium set forth in claim 8, when the variable Y is an n-digit value in a radix r, further comprising the steps of
defining the constant R as:
R=r^{m}, where m is an integer that satisfies m<n,
splitting the variable Y into an upper (n-m) digit part Y_{H} and a lower m-digit part Y_{L} by the following formula (3),
Y=Y_{H}·r^{m}+Y_{L} (3);
transforming the formula (1) to the following formula (4),
(X·Y_{H} mod M+X·Y_{L}·R⁻¹ mod M) mod M (4);
and,
executing partial formulas (4a) and (4b) of the above formula (4),
X·Y_{H} mod M (4a);
X·Y_{L}·R⁻¹ mod M (4b);
in parallel processing.
